(19) United States
(12) Patent Application Publication
(10) Pub. No.: US 2016/0109554 A1
(43) Pub. Date: Apr. 21, 2016

(54) ADAPTIVE OPTIMIZATION OF TIME OF FLIGHT (ToF) EXCHANGE

(71) Applicant: Intel Corporation, Santa Clara, CA (US)

(72) Inventors: Adrian P. Stephens, Cottenham (GB); Yuval Amizur, Kfar-Saba (IL); Leor Banin, Petach Tikva (IL)

(21) Appl. No.: 14/973,106

(22) Filed: Dec. 17, 2015

Related U.S. Application Data
(63) Continuation of application No. 13/799,121, filed on Mar. 13, 2013.
(60) Provisional application No. 61/724,083, filed on Nov. 8, 2012.

(51) Int. Cl. G01S 5/02; G01S 5/10; H04W 4/02

(52) U.S. Cl. CPC G01S 5/0289; H04W 4/023; G01S 5/10

(57) ABSTRACT

Embodiments for providing adaptive optimization of time of flight (ToF) exchange are generally described herein. In some embodiments, a mobile station includes a range management module arranged to transmit a measurement request action frame having a first flag for indicating to an access point to perform an optimized sequence for calculating the ToF, to receive ranging information in response to the transmission of the measurement request action frame having the first flag, and to calculate a time of flight based on the received ranging information.

### RELATED APPLICATION

This application is a continuation of U.S. application Ser. No. 13/799,121, filed Mar. 13, 2013, which claims the priority of priority under 35 U.S.C. 119(e) to U.S. Provisional Patent Application Ser. No. 61/724,083, filed on Nov. 8, 2012, and entitled “ADAPTIVE RESPONSE OF TIME OF FLIGHT EXCHANGE”, each of which is hereby incorporated by reference herein in their entirety.

### BACKGROUND

The proliferation of wireless devices in the recent past has been exceptional, and includes communication and computing devices that are able to exchange data or voice signals amongst each other and/or with a central location. These devices communicate typically through radio waves, over dedicated frequencies or dedicated segments of the electromagnetic spectrum. The range of these radio communications varies, and repeaters, cellular towers, or other nodes of the device's network may be used to extend that range. One example of these devices may be cellular telephones, but increasingly the devices have multiple functions, such as portable or hand held computers with wireless capabilities, e-mail sending and receiving devices, pagers, or two way radio communication devices.

The ability to estimate the relative distance between wireless nodes is becoming of upmost importance for a number of wireless device applications that require location awareness. The need for Wi-Fi devices to provide location or positioning information is increasing. The United States Federal Communications Commission's E911 telecommunication initiatives require that wireless phone providers develop a way to locate any phone that makes a 911 emergency call. Location awareness is also becoming important for asset tracking. Location techniques will also be required for many future wireless systems and devices. The majority of existing techniques directed toward distance measurement between two devices are based on received signal power. However, received signal power is a non-linear function of the distance between the wireless devices, and is both time-variant and highly dependent on the environment in which the wireless devices are communicating. This produces inaccurate distance calculations. Other location measurement techniques may provide improved results.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates a wireless system according to an embodiment;

FIG. 2 shows a frame exchange for ToF measurements according to an embodiment;

FIG. 3 illustrates a shortened frame exchange according to an embodiment;

FIGS. 4a-b illustrates frame exchanges between a station and an AP, wherein at least the station supports adaptive optimization of ToF exchange according to an embodiment;

FIG. 5 illustrates a long exchange deriving two ToF measurements according to an embodiment;

FIG. 6 is a block diagram of a wireless device according to an embodiment; and

FIG. 7 illustrates a block diagram of an example machine upon which any one or more of the techniques discussed herein may performed.

### DETAILED DESCRIPTION

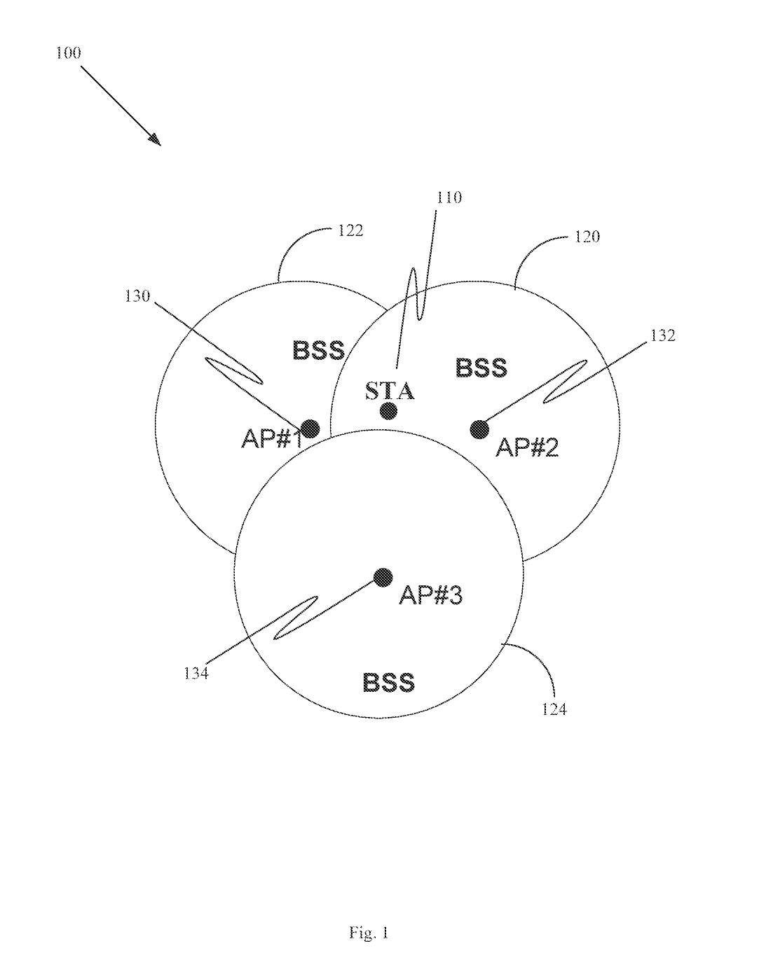

FIG. 1 illustrates a wireless system 100 according to an embodiment. In FIG. 1, a station 110 is located within the coverage area of an access point #2 (AP#2) 132. Three basic service sets (BSS) 120, 122, 124 are defined. A BSS is the basic building block of an 802.11 wireless local area network (LAN). In infrastructure mode, an AP together with associated stations (STAs) is called an infrastructure BSS. The station 110 may request a location measurement process to be initiated by an AP, e.g., AP#1 130, AP#3 134.

Time of flight (ToF) is a technique for estimating the distance between two devices. Precise time measurement may be used to provide accurate location estimation compared to the location estimation obtained from signal strength. The Institute of Electrical and Electronic Engineers (IEEE) 802.11 family of standards governs wireless networking transmission. The IEEE 802.11 standard defines a frame exchange from which ToF can be determined. More specifically, ToF may be used to measure the distance between a station and APs by directly measuring the over-the-air time-of-flight for a frame exchange sequence between a pair of devices. However, the frame exchange now defined by the IEEE 802.11 standard uses a large number of frames during an exchange to perform ToF measurements.

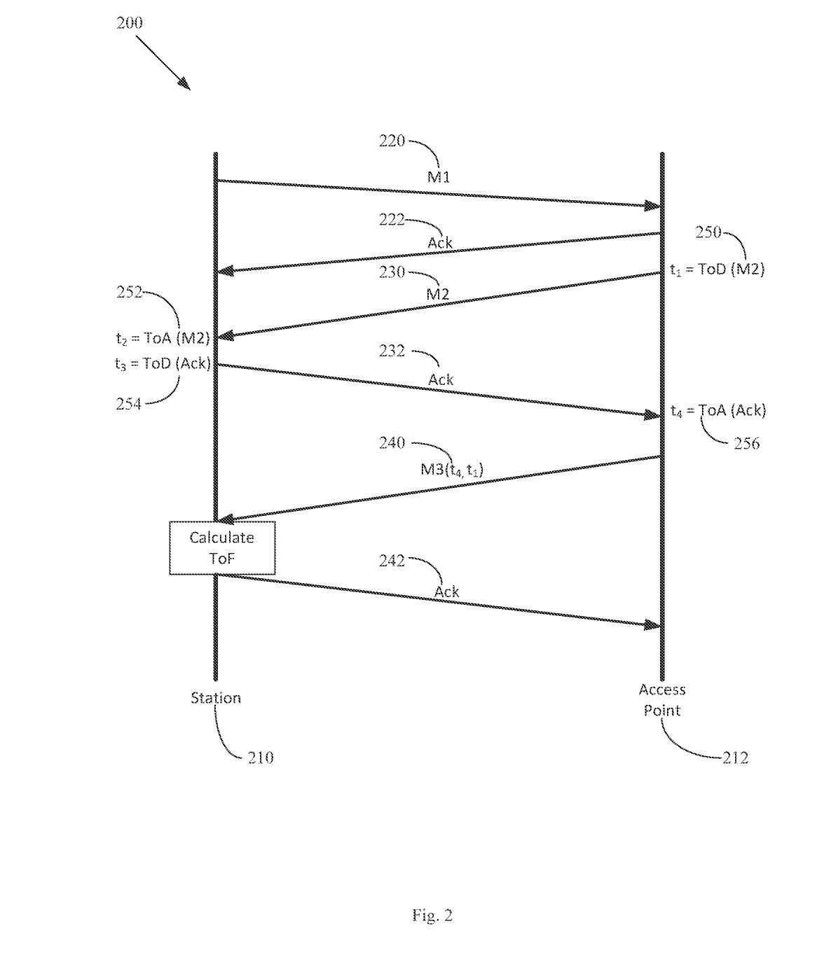

FIG. 2 shows a frame exchange 200 for ToF measurements according to an embodiment. In FIG. 2, a station 210 sends a request, M1 220, to the access point (AP) 212 soliciting the AP 212 to initiate a time of flight (TOF) measurement exchange. The AP 212 returns an acknowledgement 222 to the station 210. The AP 212 then sends a measurement frame, M2 230, to the station. The station 210 returns an acknowledgement 232 to the AP 212. The AP 212 then sends a second measurement frame, M3 240, to the station 210. The station 210 sends an acknowledgement 242 to the AP 212. The station 210 may then calculate the TOF.

M2 230 and the associated acknowledgement 232 are timed at both sides, i.e., at the AP 512 and the station 510. The AP 512 notes t₁ 250, which is the time of departure (ToD) for M2 230. The station 210 notes the time of arrival (ToA), t₂ 252, for M2 230. The station 210 also notes the time of departure, t₃ 254, for the acknowledgement 232 to M2. The AP 212 notes the ToA, t₄ 256, for the acknowledgement. The AP 212 sends M3 240, which is the difference in time between t₄ 256 and t₁ 250. Thus, M3 240 carries the AP's part of the timing measurements to the station 210. The station 210 may then calculate ToF=((t₄−t₁)−(t₃−t₂))/2. However, an issue with this type exchange is the large number of frames that is used per measurement.

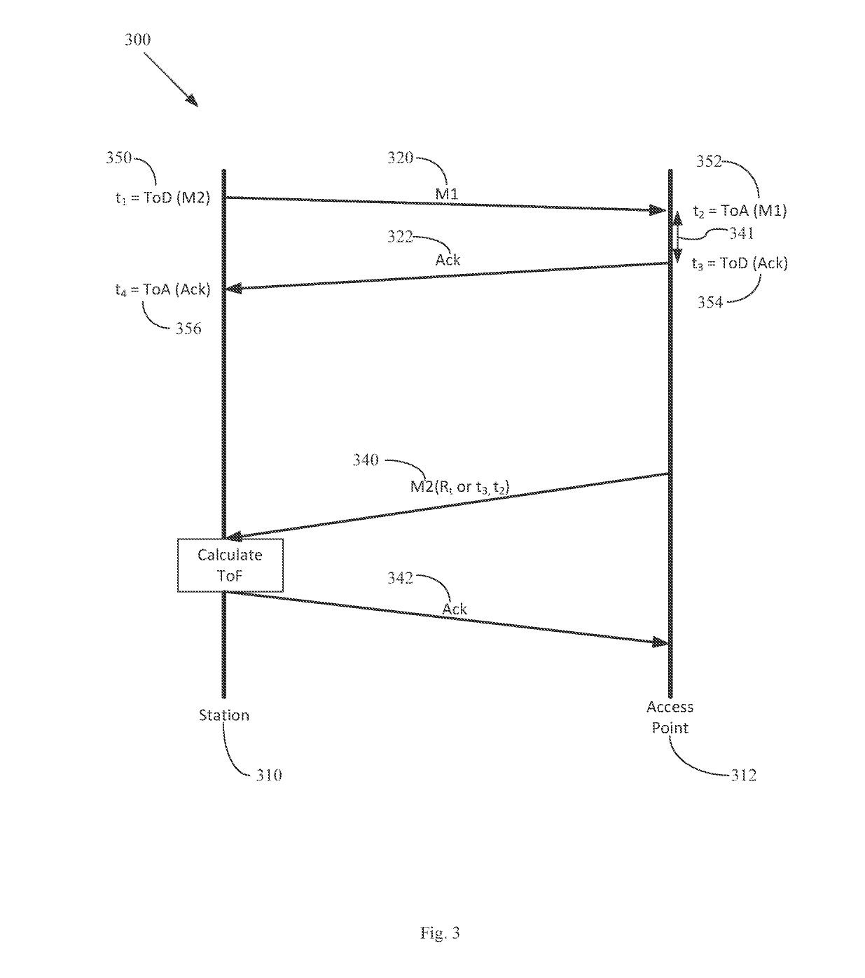

FIG. 3 illustrates a shortened frame exchange 300 according to an embodiment. The station 310 sends a request, M1 320, to the access point (AP) 312 soliciting the AP 312 to initiate a TOF measurement exchange. The AP 312 notes the time of arrival (ToA), t₂ 352, of M1 and the station notes the ToD, t₁ 350, of M1. The AP 312 returns an acknowledgement to the station 310 and notes the ToD, t₃ 354, for the acknowledgement 322. The station 310 notes the ToA, t₄ 356, for the acknowledgment 322. The AP 312 then sends frame M2 340, which may be referred to as a measurement response action frame. Frame M2 340 may include a response time 341 for the access point to respond to the measurement request action frame 320 or, alternatively, frame M2 340 may include the time between the ToA, t₂ 352, of M1 320 and the ToD, t₃ 354, for the acknowledgement 322, which may be used by the station 310 for calculating the response time 341. The station 310 sends an acknowledgement 342 for M2 340. The station 310 may then calculate ToF=((t₄−t₁)−(t₃−t₂))/2.

The frame exchange 300 reduces the length of the frame exchange sequence. However, an AP 312 might not be able to perform ToA measurements without some preparation. The original sequence 200, shown in FIG. 2, may be still be used to maintain support for 802.11 so that both the process described with reference to FIG. 3 and the process described with reference to FIG. 2 may be implemented in a seamless fashion. Alternatively, the length of the 802.11 sequence may be increased while allowing multiple ToF measurements to be made rather than one.

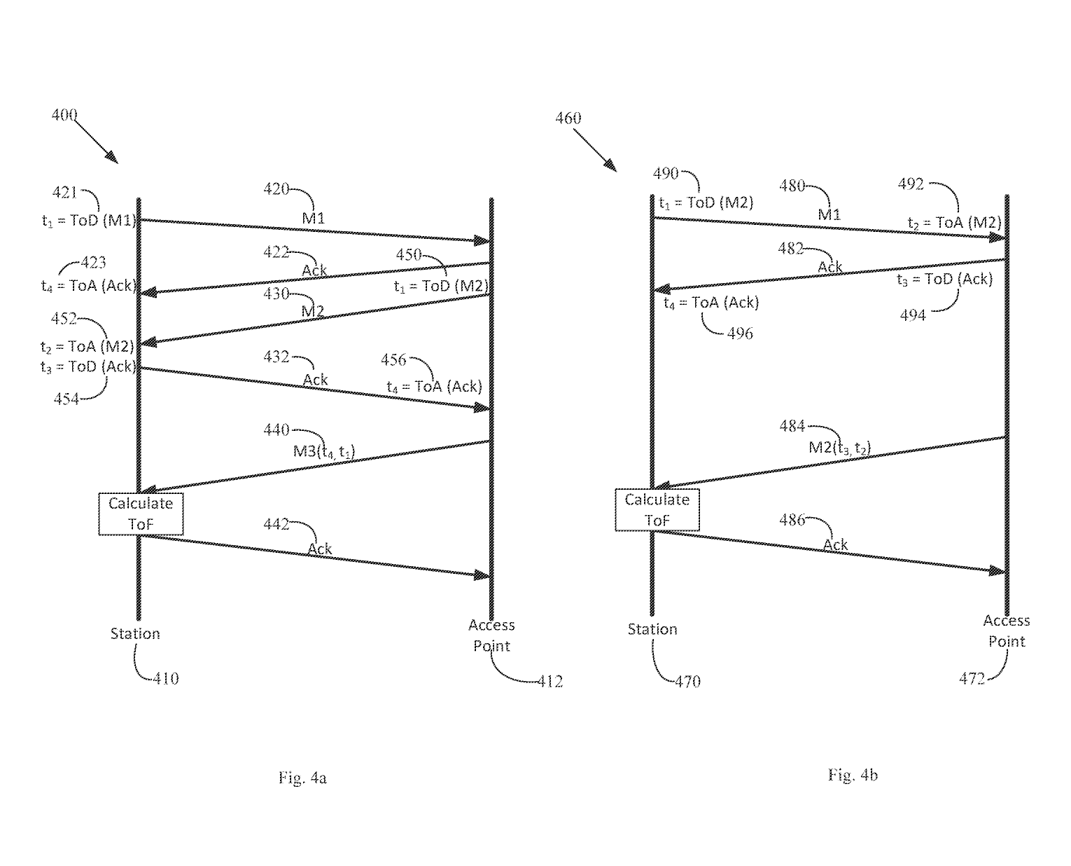

FIGS. 4a-b illustrates frame exchanges 400, 460 between a station and an AP, wherein at least the station supports adaptive optimization of ToF exchange according to an embodiment. In FIG. 4a, the station 410 supports adaptive optimization of ToF exchange, but the AP 412 does not. In other words, the AP 412 does not support unprepared ToF measurements. In FIG. 4a, the process uses six messages. The frames are similar to the process described with reference to FIG. 2, but the station 410 supports adaptive optimization of ToF exchange according to an embodiment.

The station 410 sends a request, M1 420, to the access point (AP) 412 soliciting the AP 412 to initiate a TOF measurement exchange. The AP 412 returns an acknowledgement 422 to the station 410. The station 410 notes the time of departure (ToD), t₁ 421, for M1 420 and the time of arrival (ToA), t₄ 423, for the acknowledgement 422.

The AP 412 sends frame M2 430 to the station 410. When M2 430 does not include any timing information, e.g., the ToA, t2 353 of M1 or the ToD, t3 354, of the acknowledgement, the station 410 determines that the AP 412 does not support the shortened frame exchange, as shown in FIG. 3, and discards t₁ and t₄, which will be provided by the AP 412. The station 410 thus prepares for the longer frame exchange by noting the ToA, t₂ 452, for M2 430. The station 410 also notes the time of departure, t₃ 454, for the acknowledgement 432 to M2. The AP 412 notes the ToD for M2 430, t₁ 450. The AP 412 also notes the ToA, t₄, 456 for the acknowledgement 432.

The AP 412 sends M3 440 to the station 410, wherein M3 440 provides t₄ 456 and t₁ 450. Alternatively, those skilled in the art will recognize that the AP 412 may send a calculated difference between t₄ 456 and t₁ 450. The station 410 sends an acknowledgement 442 to the access point. Thus, M3 440 carries the AP's part of the timing measurements to the station 410. The station 410 may then calculate ToF=((t₄−t₁)−(t₃−t₂))/2.

FIG. 4b shows a frame exchange 460 between a station 470 and an AP 472, wherein both support adaptive optimization of ToF exchange according to an embodiment. In FIG. 4b, the station 470 sends a request, M1 480, to the access point (AP) 472 soliciting the AP 472 to initiate a TOF measurement exchange. The AP 472 notes the time of arrival (ToA), t₂ 492, of M1 480 and the station 470 notes the ToD, t₁ 490, of M1 480. The AP 472 returns an acknowledgement 482 to the station 470 and notes the ToA, t₄ 496, for the acknowledgement 482. The AP 472 notes the ToD, t₃ 494, for the acknowledgement 482. The AP 472 then sends frame M2 484, which includes the difference in time between the ToA, t₂ 492, of M1 480 and the ToD, t₃ 494, for the acknowledgement 482. The station 470 sends an acknowledgement 486 for M2 484 that includes the difference between the t₃ 494 and t₂ 492. The station 470 may then calculate ToF=((t₄−t₁)−(t₃−t₂))/2.

In FIG. 4a, the station 410 does not a-priori know whether the AP supports adaptive optimization of ToF exchange according to an embodiment. However, the stations 410, 470 may determine the capability of the AP, 412, 472, respectively, through a capability bit that is transmitted by the AP 412, 472. The capability of the AP 412, 472 may be provided in the extended capabilities element in Beacons, Probe Response frames, neighbor AP 412, 472 advertisement frames, etc. The station 410 generates the optimized sequence directed towards an AP 412, 472 that supports it.

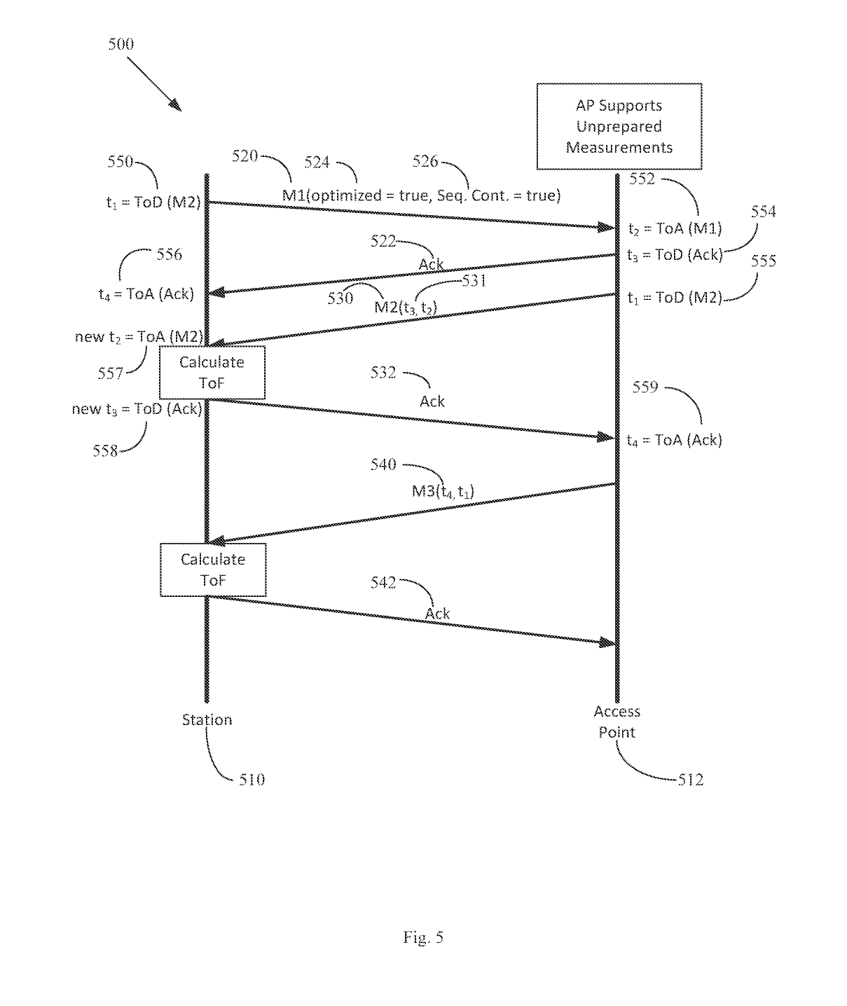

FIG. 5 illustrates a long exchange 500 deriving two ToF measurements according to an embodiment. In FIG. 5, a station 510, wanting to learn ToF measurement, sends a measurement request action frame, M1 520, to an AP 512. Message M1 520 includes a flag 524 to indicate optimized sequence. The flag 524 may be in an optional element. The flag 524 may also be a new 802.11 defined element, or a vendor-specific element, which may be defined by the WiFi Alliance. Alternatively, the flag 524 may re-use some reserved field in a fixed location in the frame, such as the high-order bits of the trigger field of the Timing Measurement Request frame. Message M1 530 may also include a second flag 526 to indicate continuation of the sequence beyond the optimized sequence in order to make multiple measurements and improve accuracy. The station 510 records the time of departure (ToD) of the outgoing frame, t₁ 550. The AP 512 receives M1 520 and generates an acknowledgment 522. If the AP 512 supports optimized sequence operation, and if optimized sequence flag 526 is set in M1 520, the AP 512 measures the time of arrival (ToA) of M1, t₂ 552, and ToD for the acknowledgement, t₃ 554.

The AP 512 then gains access to the medium and sends message M2 530. If the AP 512 supports optimized sequence operation, and if the optimized sequence flag 526 is set in M1 520, the AP 512 includes the difference 531 between t₃ 554 and t₂ 552 in M2 530. The optimized sequence flag 526 may be implemented as described above. If M1 520 indicates sequence continuation 526, the AP 512 records ToD of M2 530 as the new t₁ 555. The station 510 then generates the M2 acknowledgment 532. If message M2 530 does not include the difference 531 between t₃ 554 and t₂ 552, the station 510 discards its earlier t₁ 550, and t₄ 556 measurements. The station measures ToA of M2, new t₂ 557, and the ToD of the M2 acknowledgement, new t₃ 558. If M2 530 includes the difference 531 between t₃ 554 and t₂ 552, that station calculates ToF based on its own recorded t₁ 550 and t₄ 556 and the reported t₂ 552 and t₃ 554 from M2 530. The station 510 does not measure the ToA, i.e., the new t₂ 557, of M2 530 and ToD, i.e., new t₃ 558, of the M2 acknowledgement 532 if the sequence does not continue. If M1 520 indicated sequence continuation 526, the station 510 measures the ToA of M2 530, which becomes the new t₂ 557, and measures the ToD of M2 acknowledgement 532, which becomes the new t₃ 558. The AP 512 receives the M2 acknowledgement 532 and records the ToA of the M2 acknowledgement as the new t₄ 559.

The AP 512 gains access to the medium and transmits M3 540. The AP 512 transmits M3 540 if the AP 512 supports optimized sequence operation, and if optimized sequence flag 524 is set in M1 520, or if M1 520 indicated sequence continuation 526. M3 540 includes t₄ 559 and t₁ 555 measurements based on M2 530 and its acknowledgement 532. The station 510 receives M3 540 and generates the acknowledgement 542. The station 510 then calculates the ToF based on the received t₁ 555 and t₄, 559 and based on its measured new t₂ 557 and new t₃ 558.

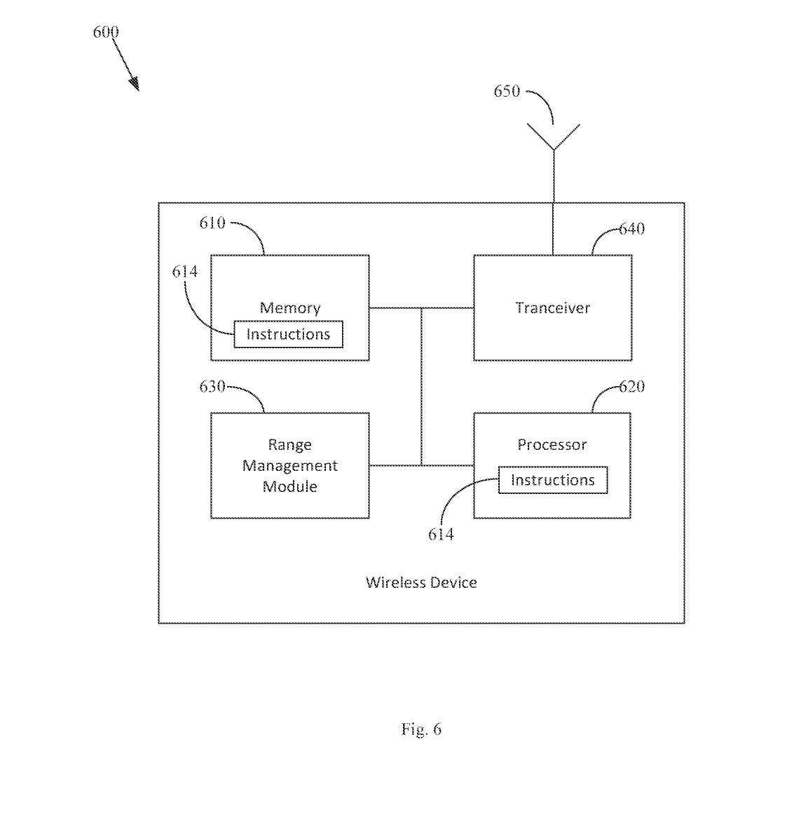

FIG. 6 is a block diagram of a wireless device 600 according to an embodiment. In FIG. 6, memory 610 is provided to store one or more sets of data structures or instructions 614 (e.g., software) embodying or utilized by any one or more of the techniques or functions described herein. The instructions 614 may also reside, completely or at least partially, within the hardware processor 620 during execution thereof. A management module 630 is provided for performing the adaptive optimization of time of flight (ToF) exchange according to an embodiment. The ToF signals are transmitted and received through an antenna 650 and processed by transceiver 640. The wireless device may be a mobile station, an access point, or other device that may perform TOF exchange according to an embodiment.

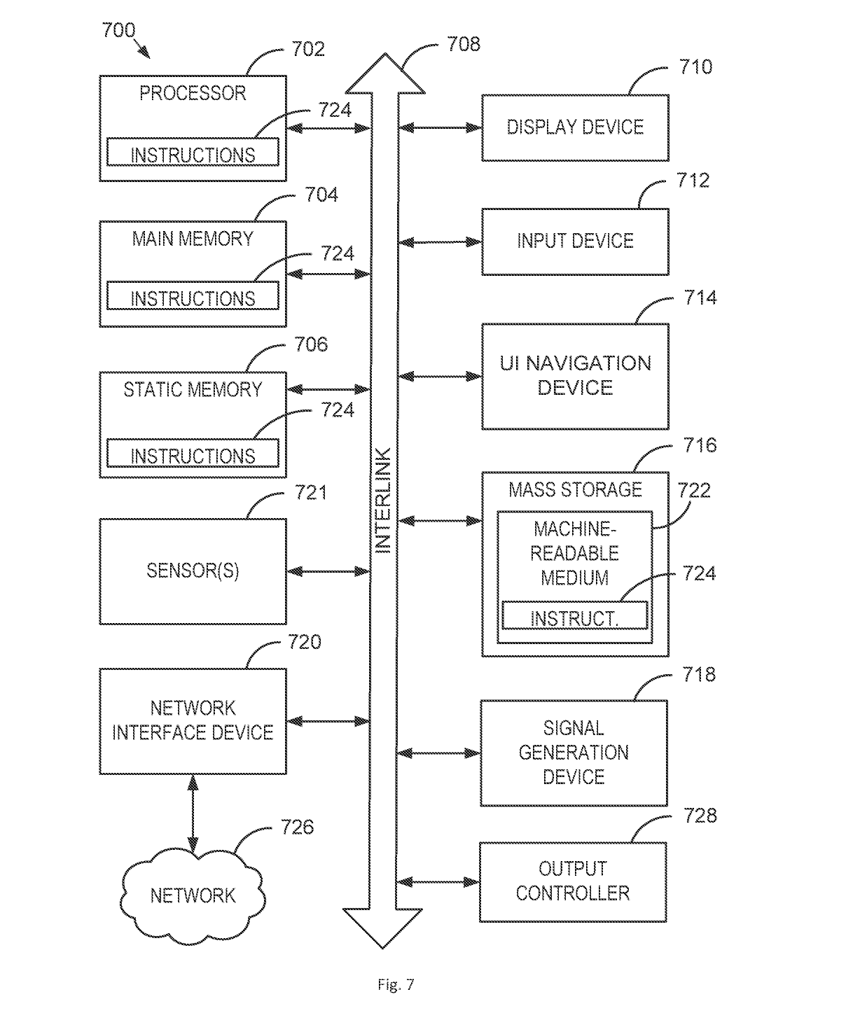

FIG. 7 illustrates a block diagram of an example machine 700 upon which any one or more of the techniques (e.g., methodologies) discussed herein may performed. In alternative embodiments, the machine 700 may operate in a standalone mode or may be connected (e.g., networked) to other machines in a network mode. In a networked deployment, the machine 700 may operate in the capacity of a server machine, a client machine, or both in server-client network environments. In an example, the machine 700 may act as a peer machine in peer-to-peer (P2P) (or other distributed) network environment.

The machine 700 may further be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine.

Further, while a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Examples as described herein may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, the modules may not be instantiated at any one moment in time. For example, where the modules include a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR)) connection to communicate or control one or more peripheral devices (e.g., a printer, card reader, etc.).

The storage device 716 may include a machine-readable medium 722 on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine-readable media.

While the machine-readable medium 722 is illustrated as a single medium, the term “machine readable medium” may include a single medium or multiple media (e.g., a centralized or distributed database, and/or associated caches and servers) that are configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium comprises a machine-readable medium with a plurality of particles having resting mass. Specific examples of massed machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and compact disk-read only memory (CD-ROM) and digital versatile disk-read only memory (DVD-ROM) disks.

The instructions 724 may further be configured for transmission and reception over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., channel access methods including Code Division Multiple Access (CDMA), Time-division multiple access (TDMA), Frequency-division multiple access (FDMA), and Orthogonal Frequency Division Multiple Access (OFDMA); and cellular networks such as Global System for Mobile Communications (GSM), Universal Mobile Telecommunications System (UMTS), CDMA 2000 1×* standards and Long Term Evolution (LTE)); Plain Old Telephone (POTS) networks; and wireless data networks (e.g., Institute of Electrical and Electronics Engineers (IEEE) 802 family of standards including IEEE 802.11 standards (Wi-Fi®), IEEE 802.16 standards (WiMax®) and others) and peer-to-peer (P2P) networks; or other protocols now known or later developed.

For example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 700, and includes digital or analog communications signals or other intangible medium to facilitate communication of such software.

### Additional Notes & Examples

Example 1 includes subject matter (such as a device, apparatus, client or system) for providing adaptive optimization of time of flight (ToF) exchange, including a range management module arranged to transmit to an access point a measurement request action frame having a first flag for indicating to the access point to perform an optimized sequence for calculating a ToF, to receive an acknowledgement from the access point in response to the access point receiving measurement request action frame, to receive a measurement response action frame from the access point in response to the transmission of the measurement request action frame having the first flag, the measurement response action frame providing a response time of the access point, and to calculate, upon receiving the response time, a time of flight based on the response time of the access point provided in the received measurement response action frame.

Example 2 may optionally include the subject matter of Example 1, wherein the range management module is further arranged to record a time of departure for the measurement request action frame, to record a time of arrival of the acknowledgment from the access point, to receive the measurement response action frame providing the response time of the access point including a time of arrival at the access point for the measurement request action frame and a time of departure at the access point for the acknowledgment, wherein the range management module calculates the time of flight (ToF) to the access point by determining a time between the time of departure of the measurement request action frame and the time of arrival of the acknowledgement from the access point, and subtracting a time between the arrival of the measurement request action frame at the access point and the time of departure at the access point of the acknowledgment.

Example 3 may optionally include the subject matter of any one or more of Examples 1-2, wherein the response time in the measurement response action frame fails to include a time of arrival at the access point for the measurement request action frame and a time of departure at the access point for the acknowledgment, and wherein a time of departure of the measurement request action frame and a time of arrival of the acknowledgement from the access point are discarded.

Example 4 may optionally include the subject matter of any one or more of Examples 1-3, wherein the measurement request action frame comprises a second flag to indicate continuation of the sequence beyond the optimized sequence to cause multiple measurements to be made, the range management module arranged to transmit to the access point an acknowledgment of the measurement response action frame, record a time of arrival of the measurement response action frame, record a time of departure of the acknowledgment of the measurement response action frame and receive a time of departure of the measurement response action frame at the access point and a time of arrival of the acknowledgment of the measurement response action frame at the access point, wherein the range management module calculates the time of flight (ToF) to the access point by determining a time between the time of departure of the measurement response action frame and the time of arrival of the acknowledgement of the measurement response action frame at the access point, and subtracting a time between the arrival time of the measurement response action frame and the time of departure of the acknowledgment to the measurement response action frame.

Example 5 may optionally include the subject matter of any one or more of Examples 1-4, wherein the first flag comprises an optional element to the measurement request action frame.

Example 6 may optionally include the subject matter of any one or more of Examples 1-5, wherein the first flag comprises an 802.11 defined element.

Example 7 may optionally include the subject matter of any one or more of Examples 1-6, wherein the first flag comprises a vendor-specific element.

Example 8 may optionally include the subject matter of any one or more of Examples 1-7, wherein the first flag uses a reserved field in a fixed location in the frame.

Example 9 may include subject matter (such as a method or means for performing acts) including transmitting to an access point by a mobile station, a measurement request action frame having a first flag for indicating to the access point to perform an optimized sequence for calculating a ToF, receiving, at the mobile station, an acknowledgement from the access point in response to the access point receiving measurement request action frame, receiving, at the mobile station, a measurement response action frame from the access point in response to the transmission of the measurement request action frame having the first flag, the measurement response action frame providing a response time of the access point, and calculating, by the mobile station upon receiving the response time, a time of flight based on the response time of the access point provided in the received measurement response action frame.

Example 10 may optionally include the subject matter of Example 9 further including recording a time of departure for the measurement request action frame, recording a time of arrival of the acknowledgment from the access point and receiving a measurement response action frame providing a time of arrival at the access point for the measurement request action frame and a time of departure at the access point for the acknowledgment.

Example 11 may optionally include the subject matter of any one or more of Examples 9-10, further including determining a time between the time of departure of the measurement request action frame and the time of arrival of the acknowledgement from the access point and subtracting a time between the arrival of the measurement request action frame at the access point and the time of departure at the access point of the acknowledgment.

Example 12 may optionally include the subject matter of any one or more of Examples 9-11, wherein the receiving the measurement response action frame providing the response time of the access point further comprises receiving the response time that fails to include a time of arrival at the access point for the measurement request action frame and a time of departure at the access point for the acknowledgment, and wherein s time of departure of the measurement request action frame and s time of arrival of the acknowledgement from the access point recorded by the mobile station are discarded.

Example 13 may optionally include the subject matter of any one or more of Examples 9-12, wherein the transmitting the measurement request action frame further comprises transmitting the measurement request action frame having a second flag to indicate continuation of the sequence beyond the optimized sequence to cause multiple measurements to be made, and in response to the second flag, the method further includes transmitting to the access point an acknowledgment of the measurement response action frame, recording a time of arrival of the measurement response action frame, recording a time of departure of the acknowledgment of the measurement request action frame and receiving a time of departure of the measurement response action frame at the access point and a time of arrival at the access point of the acknowledgment of the measurement response action frame, wherein the calculating the time of flight (ToF) to the access point further comprises determining a time between the time of departure at the access point of the measurement response action frame and the time of arrival at the access point of the acknowledgement of the measurement response action frame, and subtracting a time between the arrival time of the measurement response action frame and the time of departure of the acknowledgment to the measurement response action frame.

Example 14 may optionally include the subject matter of any one or more of Examples 9-13, wherein the transmitting the measurement request action frame having the first flag further comprises providing an 802.11 defined element in the measurement request action frame for the first flag.

Example 15 may optionally include the subject matter of any one or more of Examples 9-14, wherein the transmitting the measurement request action frame having the first flag further comprises transmitting the measurement request action frame having the first flag arranged as a vendor-specific element.

Example 16 may optionally include the subject matter of any one or more of Examples 9-15, wherein the transmitting the measurement request action frame having the first flag further comprises transmitting the measurement request action frame having the first flag in a reserved field in a fixed location in the measurement request action frame.

Example 17 may include subject matter (such as means for performing acts or machine readable medium including instructions that, when executed by the machine, cause the machine to perform acts) including transmitting to an access point by a mobile station, a measurement request action frame having a first flag for indicating to the access point to perform an optimized sequence for calculating a ToF, receiving, at the mobile station, an acknowledgement from the access point in response to the access point receiving measurement request action frame, receiving, at the mobile station, a measurement response action frame from the access point in response to the transmission of the measurement request action frame having the first flag, the measurement response action frame providing a response time of the access point, and calculating, by the mobile station upon receiving the response time, a time of flight based on the response time of the access point provided in the received measurement response action frame.

Example 18 may optionally include the subject matter of Example 17 further including recording a time of departure for the measurement request action frame, recording a time of arrival of the acknowledgment from the access point and receiving a measurement response action frame providing a time of arrival at the access point for the measurement request action frame and a time of departure at the access point for the acknowledgment.

Example 19 may optionally include the subject matter of any one or more of Examples 17-18, further includes determining a time between the time of departure of the measurement request action frame and the time of arrival of the acknowledgement from the access point and subtracting a time between the arrival of the measurement request action frame at the access point and the time of departure at the access point of the acknowledgment.

Example 20 may optionally include the subject matter of any one or more of Examples 17-19, wherein the receiving the measurement response action frame providing the response time of the access point further comprises receiving the response time that fails to include a time of arrival at the access point for the measurement request action frame and a time of departure at the access point for the acknowledgment, and wherein s time of departure of the measurement request action frame and s time of arrival of the acknowledgement from the access point recorded by the mobile station are discarded.

Example 21 may optionally include the subject matter of any one or more of Examples 17-20, wherein the transmitting the measurement request action frame further comprises transmitting the measurement request action frame having a second flag to indicate continuation of the sequence beyond the optimized sequence to cause multiple measurements to be made, and in response to the second flag, and further including transmitting to the access point an acknowledgment of the measurement response action frame, recording a time of arrival of the measurement response action frame, recording a time of departure of the acknowledgment of the measurement request action frame and receiving a time of departure of the measurement response action frame at the access point and a time of arrival at the access point of the acknowledgment of the measurement response action frame, wherein the calculating the time of flight (ToF) to the access point further comprises determining a time between the time of departure at the access point of the measurement response action frame and the time of arrival at the access point of the acknowledgement of the measurement response action frame, and subtracting a time between the arrival time of the measurement response action frame and the time of departure of the acknowledgment to the measurement response action frame.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. (canceled)

2. A first device including a memory and one or more processors, the one or more processors including circuitry, the circuitry having logic to:
process an initial timing measurement frame, received from a second device, that includes a capability field indicating that the second device is capable of capturing and sending timestamps associated with an initial timing measurement frame;
process a subsequent timing measurement frame that is subsequent to the initial timing measurement frame and that includes a first timestamp t1 and a second timestamp t4 associated with the initial timing measurement frame; and
calculate, based on at least the first timestamp and the second timestamp a timing value that is a measurement of a relative location between the first device and the second device.

3. The first device of claim 2, wherein the circuitry further has logic to:
generate a timing measurement request frame to initiate a timing measurement procedure at the second device; and
process the initial timing measurement frame received in response to the timing measurement request frame.

4. The first device of claim 2, wherein the circuitry has further logic to calculate a response time for the second device based on stored values for a time of departure of the timing measurement request frame and a time of arrival of an acknowledgment of the timing measurement request frame.

5. The first device of claim 4, wherein the circuitry further includes logic to:
process values for the time of departure for the timing measurement request frame and the time of arrival of the acknowledgment of the timing measurement request frame from the second device; and
discard the stored values for the time of departure of the measurement request action frame and the time of arrival of the acknowledgement of the timing request frame upon receiving the initial timing measurement frame.

6. The first device of claim 2, wherein the circuitry has further logic to:
generate, for transmission to the second device, an acknowledgment (Ack) of the initial timing measurement frame; and
store, in the memory, a value for a time t2 at which the initial timing measurement frame arrives and a value for a time t3 at which the Ack is transmitted.

7. A non-transitory computer-readable storage medium that stores instructions for execution by one or more processors of a user station (STA) to perform operations comprising:
generating a timing measurement request frame to initiate a timing measurement procedure at a second device;
processing an initial timing measurement frame, received from another device responsive to the timing measurement request frame, that includes a capability field indicating that the other device is capable of capturing and sending timestamps associated with the initial timing measurement frame;
processing a subsequent timing measurement frame that is subsequent to the initial timing measurement frame and that includes a first timestamp t1 and a second timestamp t4 that is associated with the initial timing measurement frame; and
calculating a time of flight between the STA and the other device based on at least the timestamps associated with the initial timing measurement frame.

8. The non-transitory computer-readable storage medium of claim 7, wherein the other device is an access point (AP).

9. The non-transitory computer-readable storage medium of claim 8, wherein the instructions cause the STA to perform further operations comprising:
capturing timestamps associated with the timing measurement request frame and an acknowledgement of the timing measurement request frame to detect a response time for the other device.

10. A user station (STA), comprising:
a wireless communication device including a radio, a processor, and a memory, the wireless communication device to:
process an initial timing measurement frame, received from a second device, that includes a capability field indicating that the second device is capable of capturing timestamps associated with the initial timing measurement frame;
process a subsequent timing measurement frame that is subsequent to the initial timing measurement frame and that includes a timestamp t1 representative of a time at which the initial timing measurement frame was transmitted by the second device; and
calculate a time of flight between the STA and the second device, based on at least the timestamp t1 and on the time t2 at which the initial timing measurement frame was received at the STA.

11. The STA of claim 10, wherein the wireless communication device is further to:
generate a timing measurement request frame to initiate a timing measurement procedure at the second device; and
calculate a response time for the second device based on stored values for a time of departure of the timing measurement request frame and a time of arrival of an acknowledgment of the timing measurement request frame.

12. The STA of claim 10, wherein the wireless communication device is further to:
generate, for transmission to the second device, an acknowledgment (Ack) of the initial timing measurement frame; and
store, in the memory, a value for the time t2 at which the initial timing measurement frame arrives and a value for a time t3 at which the Ack is transmitted.

13. The STA of claim 10, further comprising at least two antennas.

14. The STA of claim 10, further comprising a touch screen display.

15. A device including a memory and one or more processors, the one or more processors including circuitry, the circuitry having logic to:
receive a timing measurement request frame from a requesting user station (STA) to initiate a timing measurement procedure at the device; and
provide, responsive to the timing measurement request frame, an initial timing measurement frame that includes an indication of the device is capable of capturing and transmitting timestamps associated with the initial timing measurement frame.

16. The device of claim 15, wherein the circuitry has further logic to:
provide a subsequent timing measurement frame, subsequent to the initial timing measurement frame, that includes a first timestamp t1 and a second timestamp t4 associated with the initial timing measurement frame.

17. The device of claim 15, wherein the device is an access point (AP).
